(19) United States
(12) Patent Application Publication
(10) Pub. No.: US 2004/0151828 A1
(43) Pub. Date: Aug. 5, 2004

(54) METHOD FOR FABRICATION AND ALIGNMENT OF MICRO AND NANOSCALE OPTICS USING SURFACE TENSION GRADIENTS

(76) Inventor: Anis Zribi, Schenectady, NY (US)

Correspondence Address: CANTOR COLBURN, LLP, 55 GRIFFIN ROAD SOUTH, BLOOMFIELD, CT, 06002

(21) Appl. No.: 10/248,651

(22) Filed: Feb. 4, 2003

(51) Int. Cl. B05D 5/12

(52) U.S. Cl. 427/58; 427/299; 205/766

(57) ABSTRACT

A method for forming and aligning an optical structure includes depositing a polymer-based droplet upon a substrate and creating a gradient of surface tension at a droplet/substrate interface between the droplet and the substrate, so as to cause the droplet to move to a desired position on the substrate. The wettability of the substrate is adjusted so as to configure the shape of the droplet to have desired optical properties. The droplet is cured, thereby affixing the droplet at the desired position and with the desired optical properties.

### BACKGROUND OF THE INVENTION

The present disclosure relates generally to optical component fabrication and, more particularly, to a method for fabrication and alignment of micro and nanoscale optical components using surface tension gradients.

Optical components are used to transmit and process light signals in various fields of technology, such as telecommunications, data communications, avionic control systems, sensor networks and automotive control systems, to name a few. Generally speaking, such optical components are classed as either passive or active. Examples of passive optical components are those that provide polarization control, transmission, distribution, splitting, combining, multiplexing, and demultiplexing of a light signal. Active optical components include those requiring electrical connections to power and/or control circuitry, such as laser sources and photodiode detectors, and/or to process light signals using electro-optic effects, such as provided by certain non-linear optical materials.

The increasing demands for miniaturization and parallel processing of optoelectronic devices, as well as the maturity of processing technologies in microscale and nanoscale fabrication have resulted in the development of microlenses and other miniaturized optical componentry. Existing technologies for fabricating microscale components (such as microlenses, 45-degree mirrors and waveguides, for example) include fiber end-surface etching, fiber tip etching and melting, laser micromachining, polymer island melting, and grey-scale photolithography/etching.

As will be appreciated, the accurate fabrication and alignment of three dimensional (3D) micro and nano-optic polymer-based devices takes on greater significance in achieving minimal optical losses in hybrid photonic packages. Not surprisingly, this task becomes increasingly daunting as the dimensions of these devices shrink to the micron and submicron length scales in single mode applications. At these length scales, fabrication tools that are associated with presently available fabrication techniques, such as lithography, suffer from various limitations. These restrictions may be inherent to the technique itself, related to the properties of the available photoresists, or even to the instrument used for pattern transfer. Accordingly, there is a need for a simple, accurate and low cost method for fabricating and accurately aligning polymer-based optoelectronic devices.

### BRIEF DESCRIPTION OF THE INVENTION

The above discussed and other drawbacks and deficiencies of the prior art are overcome or alleviated by a method for forming and aligning an optical structure. In an exemplary embodiment, the method includes depositing a polymer-based droplet upon a substrate and creating a gradient of surface tension at a droplet/substrate interface between the droplet and the substrate, so as to cause the droplet to move to a desired position on the substrate. The wettability of the substrate is adjusted so as to configure the shape of the droplet to have desired optical properties. The droplet is cured, so as to affix the droplet at the desired position and with the desired optical properties.

In another aspect, a method for forming and aligning a microlens structure for an optoelectronic package includes disposing a polymer-based droplet between a substrate and an optoelectronic chip. A gradient of surface tension at a droplet/substrate interface between the droplet and the substrate is created so as to cause the droplet to move to a desired position between the substrate and the optoelectronic chip. In addition, the wettability of at least one of the substrate and the optoelectronic chip is adjusted so as to configure the shape of the droplet to have desired optical properties. The droplet is cured, thereby affixing the droplet at the desired position and with the desired optical properties.

### BRIEF DESCRIPTION OF THE DRAWINGS

Referring to the exemplary drawings wherein like elements are numbered alike in the several Figures:

FIG. 1 is a block diagram illustrating a method for forming and aligning an optical component, in accordance with an embodiment of the invention;

FIGS. 2 through 4 illustrate the formation and alignment of a polymer-based droplet upon an optical substrate is coated with a monolayer of a photosensitive (e.g., a photoisomerizable) coating, in accordance with one embodiment of the method of FIG. 1;

FIGS. 5 and 6 illustrate the formation and alignment of a polymer-based droplet between and optical substrate and a Vertical Cavity Surface Emitting Laser (VCSEL) chip through electrowetting principles, in accordance with another embodiment of the method of FIG. 1; and

FIGS. 7 and 8 illustrate the formation and alignment of a polymer-based droplet upon an optical substrate through the Marangoni effect, in accordance with another embodiment of the method of FIG. 1.

### DETAILED DESCRIPTION OF THE INVENTION

Disclosed herein is a_Toc513457888method for fabrication and alignment of micro and nanoscale optical components using surface tension gradients, which begin to become a dominant force at submillimeter length scales. Broadly stated, the present disclosure utilizes surface tension properties in order to both fabricate and align polymer-based micro and nano optic devices (e.g., liquid lenslets) with respect to each other for hybrid optoelectronic packages. The method embodiments discussed hereinafter are each based on the concept of fluid flow under surface tension gradients. As a result of the ability to dynamically control the positioning and shape of a polymer droplet with respect to a substrate, a variety of polymer-based micro and nano optic devices, such as lenses, tilted mirrors and waveguides, for example, can be fabricated. In the individual embodiments described herein, there is shown an example of the fabrication and alignment of a polymer-based microlens, based on different physicochemical concepts. It should be appreciated, however, that the principles described herein after are also applicable in the formation and alignment of other optical structures, in addition to the exemplary microlens structure.

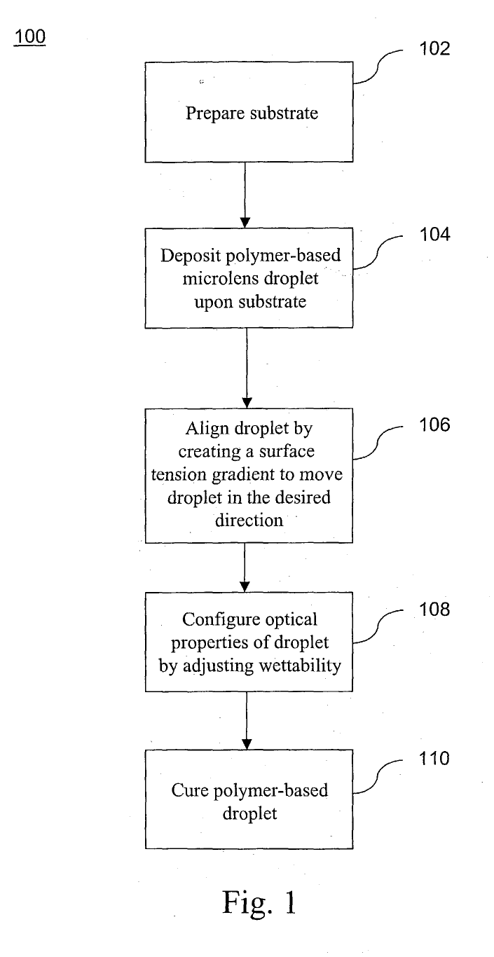

Referring initially to FIG. 1, there is shown a block diagram illustrating a method 100 for forming and aligning an optical structure (e.g., a microlens), in accordance with an embodiment of the invention. As shown in the diagram, a first step in each method embodiment is to prepare an optical substrate, such as silicon for example, as shown in block 102. Thereafter, a droplet of a polymer-based microlens material is deposited on top of the optical substrate, as shown in block 104. Once deposited, the polymer droplet is aligned at the desired location by creating a gradient of surface tension at the droplet/substrate interface so as to cause the droplet to move along the surface of the substrate, as indicated in block 106. The specific manner of creating the surface tension gradient may be implemented in any of a number of ways, as will be described later.

After the droplet is positioned, the optical properties thereof are manipulated (block 108) by altering the surface wettability so as to produce the desired focal length and numerical aperture of the resulting lenslet. More specifically, the wetting contact angle of the droplet is altered, thereby changing the shape of the droplet. Finally, once the desired location and the shape of the droplet are obtained, the droplet is then cured (i.e., solidified by applying heat, photoirradiation at a specific wavelength, and/or simple cooling, depending on the type of polymer used) to result in an accurately aligned optical component as shown in block 110.

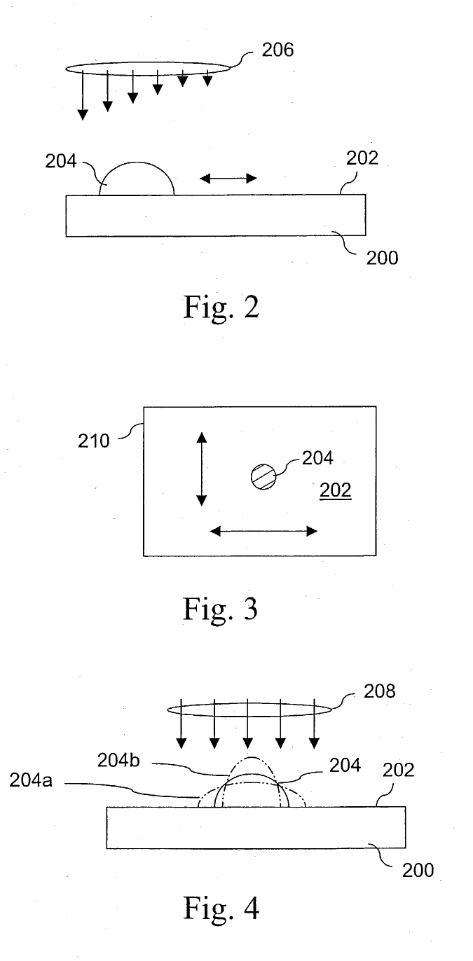

Referring generally to FIGS. 2 through 4, a first embodiment of the optical alignment and shaping of the polymer droplet is depicted. In this embodiment, photoirradiation is used to modify the wetting behavior of the polymer droplet to the substrate lying thereunderneath. An optical substrate 200 is coated with a monolayer 202 of a photoisomerizable coating (e.g., monolayers of long chain thymine-terminated thiols). A micro-sized polymer droplet 204 (having a diameter on the order of about one micron or less) is then deposited onto the photoisomerizable coating 202. By photoirradiating the photoisomerizable monolayer located underneath the droplet in an asymmetric manner (as represented by arrows 206), the polymer droplet 204 is forced to move under the effect of surface tension gradients. In other words, the droplet 204 will move from an area of relatively lower surface energy to an area of relatively higher surface energy.

Because this phenomenon is reversible, the direction of motion of the droplet 204 is therefore controllable in both an x-direction and a y-direction within the plane of the substrate 200, as shown in FIG. 3. Thus, it will be seen that a controlled asymmetric application of photoirradiation (exemplary wavelengths of the irradiation) to the monolayer coating 202 of substrate 200, will result in a controlled surface energy gradient, thereby resulting in a surface tension gradient. In this manner, the droplet 204 is precisely positioned at the desired location upon the substrate 200. Then, upon application of a light beam focused in a symmetrical manner at a suitable wavelength (e.g., about 240-280 nm in the near UV range) onto the photoisomerizable monolayer 202 underneath the droplet 204, for a given amount of time, the contact angle of the droplet 204 with respect to the substrate 200 may be modified to achieve a desired geometry for the lens. This is particularly illustrated in FIG. 4, with arrows 208 representing a symmetrical application of photoirradiation, wherein the wettability of the monolayer 202 is altered. The wettability may be increased to decrease the contact angle, as shown by dashed droplet 204a, or the wettability may be decreased to increase the contact angle, as shown by dashed droplet 204b. Since the wettability is reversible, the focal distance of the lens and its optical properties can thus be adjusted in this manner to fit desired specifications.

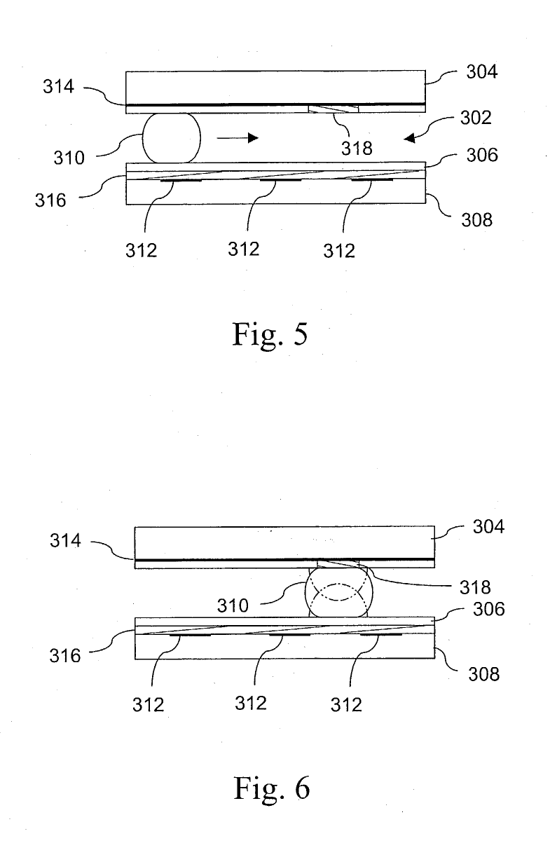

FIGS. 5 and 6 illustrate an alternative embodiment of the microlens fabrication and alignment method, wherein the principle of electrowetting is used to form and accurately align the microlens to other optoelectronic components. In the example illustrated, a microlens is to be formed in a gap 302 between an optoelectronic chip 304, such as a Vertical Cavity Surface Emitting Laser (VCSEL), and a waveguide 306 laying on a substrate 308 located immediately underneath the chip 302. Then, a polymer droplet 310 is dispensed between the substrate and the chip. By applying an electric field to the droplet 310, the wetting behavior of the droplet can be modified.

Accordingly, a set of insulated electrodes 312 is provided within the bottom substrate 308, while a ground electrode 314 is provided within the chip 304. An insulating layer 316 isolates the electrodes 312 from the waveguide portion 306 of the substrate 308. The electrodes 312 are individually configured so as to have the ability to generate an asymmetric electric field between the substrate surface and the VSCEL chip. In this manner, generated surface tension gradients will cause the droplet 310 to be moved in accordance with the orientation of the applied electric field. Both the electrodes 312 and the ground electrode 312 may be formed by conventional semiconductor fabrication techniques, such as metal deposition and etching, or by damascene processing, wherein a dielectric material is etched and the conductive electrode material is filled within etched trenches and thereafter planarized by chemical mechanical polishing.

As shown in FIG. 5, the droplet 310, in the presence of an asymmetric electric field, is caused to move in the direction toward the optical output 318 of the VSCEL. Although FIG. 5 is a cross sectional view showing movement of the droplet 310 in a single direction, it will be understood that the droplet 310 may be made to move in any direction along the planar surface of the waveguide 306.

When the droplet 310 is positioned over the VCSEL output 318, the principle of electrowetting is further employed to manipulate the contact angle of the droplet 310 with the chip 304 and the waveguide 306. As is particularly shown in FIG. 6, a symmetrical application of an electric field at the desired location of the droplet 310 is used to increase the wettability of one surface and/or decrease the wettability of the opposing surface to achieve the desired optical properties. For example, the droplet 310 may remain in contact with both the chip 304 and the waveguide 306. Alternatively, the droplet 310 can be made to be in contact with one or the other of the surfaces, as indicated by the dashed droplets 310a, 310b.

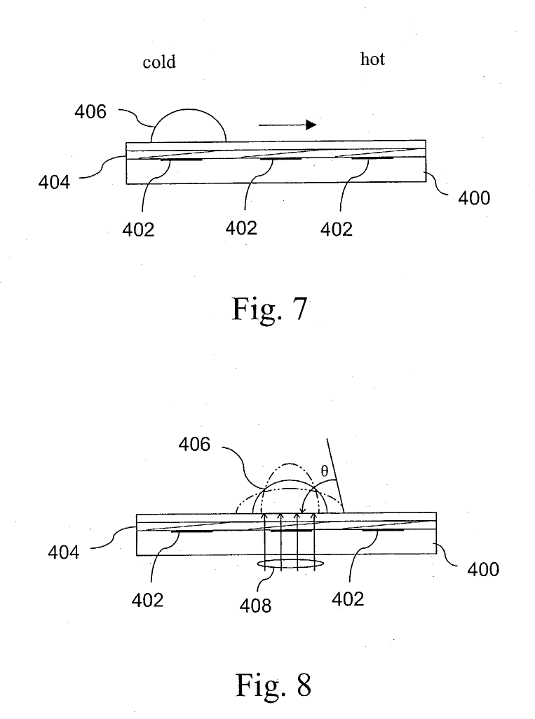

Finally, FIGS. 7 and 8 illustrate still an alternative embodiment of the microlens fabrication and alignment method, wherein the Marangoni effect is used to form and accurately align the microlens to associated optoelectronic components. As is known, the Marangoni effect is a phenomenon whereby a surface temperature gradient can modify the wetting properties of a liquid droplet to a substrate by formation of surface tension gradients. Thus, similar to the photoirradiation and electrowetting embodiments, if a droplet is heated in an asymmetric way, it can be moved in a desired direction. By controlling the manner in which the droplet is asymmetrically heated, the Marangoni effect can be employed to accurately position the lens in the appropriate location. Furthermore, by subsequently applying symmetric heat to the droplet, the contact angle between the droplet and the substrate can be varied, thus changing the microlens geometry. Once the optical properties of the lens are configured to fit the specified requirements the position and the geometry of the lens are fixed by curing the polymer.

In this regard, an optical substrate 400 includes an array of micro resistive heating elements 402 formed therein, similar to the electrodes in the embodiment of FIGS. 5 and 6. Again the heating elements 402, along with an insulating layer 404 may be formed by conventional semiconductor processing techniques. Upon deposition of a polymer droplet 406, the substrate 400 is heated in an asymmetrical manner such that a surface temperature gradient result in a surface tension gradient in accordance with the Marangoni effect. As shown in FIG. 7, the droplet 406 will thus be caused to move from a colder area on the substrate 400 to a hotter area. Then, after the droplet 406 is positioned at the desired location, the shape thereof is manipulated by symmetric heating so as to change the wettability of the substrate surface. By increasing the applied heat (lines 408) to the droplet 406, the wettability is increased, leading to a reduction in the contact angle, θ. Conversely, as the droplet is cooled, the contact angle is increased.

It will thus be appreciated that the fabrication and accurate alignment of polymer-based optoelectronic devices may be attained through surface tension manipulation, followed by a wettability adjustment for desired device/component characteristics. Regardless of the particular manner of surface tension gradient/wettability manipulation (i.e., photoirradiation, electrowetting or temperature gradient), microsized and even nanosized optical components, such as lenslets, may be formed and positioned so as to reduce optical losses otherwise resulting from misalignment of components of smaller dimensions.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for forming and aligning an optical structure, the method comprising:
depositing a polymer-based droplet upon a substrate;
creating a gradient of surface tension at a droplet/substrate interface between said droplet and said substrate, so as to cause said droplet to move to a desired position on said substrate;
adjusting the wettability of said substrate so as to configure the shape of said droplet to have desired optical properties; and
curing said droplet, so as to affix said droplet at said desired position and with said desired optical properties.

2. The method of claim 1, wherein said creating a gradient of surface tension at said droplet/substrate interface is implemented by asymmetrical photoisomerization of said substrate.

3. The method of claim 2, further comprising preparing said substrate by forming a monolayer coating of a photoisomerizable material thereon.

4. The method of claim 3, wherein said adjusting the wettability of said substrate is implemented by symmetrical photoisomerization of said substrate.

5. The method of claim 1, wherein said creating a gradient of surface tension at said droplet/substrate interface is implemented by asymmetrical electrowetting of said substrate.

6. The method of claim 5, wherein said asymmetrical electrowetting further comprises applying an asymmetrical electric field through a plurality of electrodes formed within said substrate.

7. The method of claim 6, wherein said adjusting the wettability of said substrate is implemented by symmetrical electrowetting of said substrate.

8. The method of claim 7, wherein said symmetrical electrowetting further comprises applying a symmetrical electric field through said plurality of electrodes formed within said substrate.

9. The method of claim 1, wherein said creating a gradient of surface tension at said droplet/substrate interface is implemented by asymmetrical heating of said substrate.

10. The method of claim 9, wherein said asymmetrical heating further comprises creating a temperature gradient through a plurality of resistive heating elements formed within said substrate.

11. The method of claim 10, wherein said adjusting the wettability of said substrate is implemented by symmetrical heating of said substrate.

12. The method of claim 11, wherein said symmetrical heating further comprises applying heat to said droplet through one or more adjacent of said plurality of resistive heating elements formed within said substrate.

13. A method for forming and aligning a microlens structure for an optoelectronic package, the method comprising:
disposing a polymer-based droplet between a substrate and an optoelectronic chip;
creating a gradient of surface tension at a droplet/substrate interface between said droplet and said substrate, so as to cause said droplet to move to a desired position between said substrate and said optoelectronic chip;
adjusting the wettability of at least one of said substrate and said optoelectronic chip so as to configure the shape of said droplet to have desired optical properties; and
curing said droplet, thereby affixing said droplet at said desired position and with said desired optical properties.

14. The method of claim 13, wherein said creating a gradient of surface tension at said droplet/substrate interface is implemented by asymmetrical photoisomerization of said substrate.

15. The method of claim 14, further comprising preparing said substrate by forming a monolayer coating of a photoisomerizable material thereon.

16. The method of claim 15, wherein said adjusting the wettability of said at least one of said substrate and said optoelectronic chip is implemented by symmetrical photoisomerization.

17. The method of claim 13, wherein said creating a gradient of surface tension at said droplet/substrate interface is implemented by asymmetrical electrowetting of said at least one of said substrate and said optoelectronic chip.

18. The method of claim 17, wherein said asymmetrical electrowetting further comprises applying an asymmetrical electric field through a plurality of electrodes formed within said substrate and said optoelectronic chip.

19. The method of claim 18, wherein said adjusting the wettability of said substrate is implemented by symmetrical electrowetting of said at least one of said substrate and said optoelectronic chip.

20. The method of claim 19, wherein said symmetrical electrowetting further comprises applying a symmetrical electric field through said plurality of electrodes formed within said substrate and said optoelectronic chip.

21. The method of claim 13, wherein said creating a gradient of surface tension at said droplet/substrate interface is implemented by asymmetrical heating of said substrate.

22. The method of claim 21, wherein said asymmetrical heating further comprises creating a temperature gradient through a plurality of resistive heating elements formed within said substrate.

23. The method of claim 22, wherein said adjusting the wettability of said substrate is implemented by symmetrical heating of said substrate.

24. The method of claim 23, wherein said symmetrical heating further comprises applying heat to said droplet through one or more adjacent of said plurality of resistive heating elements formed within said substrate.
